(19) United States
(12) Patent Application Publication
(10) Pub. No.: US 2004/0022422 A1
(43) Pub. Date: Feb. 5, 2004

(54) Authentication apparatus and authentication method

(76) Inventors: Masaki Yamauchi, Ibaraki-shi (JP); Ichiro Okabayashi, Ikoma-shi (JP); Yasuhiro Mori, Izumi-shi (JP); Akihiro Kawabata, Daito-shi (JP); Sadato Yoden, Kadoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/628,325

(22) Filed: Jul. 29, 2003

(30) Foreign Application Priority Data
Aug. 2, 2002 (JP) 2002-226532

(51) Int. Cl. G06K 9/00

(52) U.S. Cl. 382/115; 379/142.05

(57) ABSTRACT

Information necessary for authenticating a target (target information) is obtained by a target information obtainment unit 11 and a user input unit 12. Obtained target information is inputted in an authentication target information processing unit 40 via an operation control unit 30, and a person, an item and the like are authenticated by a target information authentication unit 41. Also, location information necessary for identifying a present location by a GPS data receiving unit 51 or a location information receiving unit 52. This location information is obtained from a base station and the like of a GPS satellite, a cellular phone and a PHS. Location information authentication unit 71 authenticates a location based on the obtained location information and information stored in a storage unit 90 in advance. Location information DB 72 is used at the time of this authentication.

### BACKGROUND OF THE INVENTION

(1) Field of the Invention

This present invention relates to an authentication apparatus whose authentication target is a specific person or a specific item, especially, authentication apparatus capable of authenticating when those targets exist at a specific location or specific time.

(2) Description of the Related Art

Conventionally, there are cases where that “a specific object (a thing or a person) exists or existed at a specific location” needs to be managed. One example is “visiting management” in which the outdoor activity of a sales person. is supervised by his or her supervisor. In this case, in the prior art, the above-mentioned management is performed by making a sales man have a GPS terminal or a cellular phone and the like (“terminal and the like” is used from here), performing “location chase” or “location determination”, and sending the location information and the like to a management server that is used by his or her boss.

Also, for example, the cases of related art 1 “location information communication system” listed in the Japanese Laid-Open Patent application No. 2000-209641, related art 2 “geography data manager” listed in the Japanese publication No. 2001-503134, related art 3 “information processing apparatus” listed in the Japanese Laid-Open Patent application No. 2001-91291, and related art 4 “location management system” listed in the Japanese Laid-Open Patent application No. 2000-354268 make it possible to confirm and determine the location based on the location information of the specific terminal. Further, related art 5 “location information management apparatus” listed in the Japanese Laid-Open Patent application No. 2000-197098 makes it possible to share location information with terminals which have notification function of location information. In addition, related art 6 “a cellular phone for search” listed in the Japanese Laid-Open Patent application No. 2000-304564 makes it possible to obtain the location information of the specific person (wanderer).

Also, related art 7 “information providing system” listed in the Japanese Laid-Open Patent application No. 2001-119761 makes it possible to obtain information that is required in advance by a user when the user of a terminal goes to the specific location. Also, related art 8 “taken picture management method” listed on the Japanese Laid-Open Patent application No. 2001-36840 makes it possible to attach the photograph location information to the picture taken with a digital camera.

Also, an authentication method in which voice print data is used is listed as “a cellular phone” and the like in the Japan Laid-Open Patent application No. 1996-223281. Also, an authentication method in which picture data indicating facial features is listed as “face picture recognition system” and the like listed in the Japanese Laid-Open Patent application No. 1999-85988. In addition, an authentication method in which iris data is used is listed as “an iris recognition device and an iris recognition method” in the Japanese Laid-Open Patent application No. 1997-212644 and the like.

However, giving each specific person a single apparatus and sending location information to the apparatus are musts in these related arts. Therefore, they are useless in the “masquerade” case, for example, the case where a terminal is brought to a specific location by a person other than a specific person.

Also, they are also useless in the case where there is a need to confirm that “a specific object (a thing or a person) exists or existed at a specific location (place)” when “indefinite number of things” exist from the viewpoint of a side who wants to confirm “the specific thing or person”. When a specific object (a thing or a person) is not connected to a specific terminal and the like one-by-one, a prior terminal and the like cannot perform authentication. In other words, these problems occur because there are no terminal device capable of authenticating both of “location (place)” and “a thing or a person” or a system including a terminal device and a server device.

More specifically, arts that function effectively are required in the following respective situations.

(1) the situation where that “a specific item” exists in “a specific location” or “a specific person” and “a specific item” are required to be authenticated (such as authentications of deliveries to specific addresses, and sending and receiving item)

(2) the situation where that “a specific person” exists at “a specific location” is required to be authenticated (management of traveling salesman, management of orienteering circumstances)

(3) the situation where that “a specific behavior or a specific transfer” of “object (such as a person or an item and the like)” is required to be authenticated (management of a business trip, management of dumping industrial wastes, copyright proof of videotaped data or recorded data, and the like)

(4) the situation where that new secondary effect is required by two or more “authentication of an object and its location” (for example, remote lock management for a specific facility).

Also, in the above-mentioned related arts 1˜5, it is impossible to identify and authenticate a person. Also, the above-mentioned related art 6 or 7 cannot handle so-called “masquerade” case, information to be provided becomes open to a masquerade user. In the case of the above-mentioned remote lock management, the lock is unlocked.

Further, related art 8 cannot attach information on a photographer. Even if location information on a location where a photograph is taken and a photographer is attached to picture data by adding such a device, the device cannot function as an authentication device because it is easy to be altered.

### SUMMARY OF THE INVENTION

The present invention is made considering the above-mentioned problems, and its aim is providing an authentication apparatus with a high accuracy as to correctness of the existence of a specific person or a specific item.

In order to achieve the above-mentioned aim, the authentication apparatus concerning the present invention is an authentication apparatus for authenticating a specific object as a target, comprising: a target information obtainment unit operable to obtain first target information that characterizes the object from said object, a target information authentication unit operable to authenticate the object based on the obtained first target information, a location information obtainment unit operable to obtain location information showing a location where the object exists, and a location information addition unit operable to associate the obtained location information with the first target information concerning the object who is authenticated.

In this way, it is possible to grasp where a correct object exists because the validity of the object as an authentication target is authenticated and the location information of the location where the authenticated target exists is added.

Further, in order to achieve the above-mentioned aim, the authentication apparatus concerning the present invention is an authentication apparatus for authenticating validity and an existence of a specific object as a target, comprising: a target information obtainment unit operable to obtain target information that characterizes the object, a location information obtainment unit operable to obtain location information showing a location where the object exists, a target information authentication unit operable to authenticate the object based on the obtained target information, a location information authentication unit operable to authenticate the location where the object exists based on the obtained location information, and an existence authentication unit operable to authenticate the existence of the object when the object is authenticated and the location information is authenticated.

The correctness of the object as an authentication target is authenticated in this way, which makes it possible to grasp the fact that a correct object existed at a due location.

Further, in order to achieve the above-mentioned aim, the authentication apparatus concerning the present invention is an authentication system comprising: an authentication server for authenticating validity and an existence of an object as a target, the object being at least one of a specific person and a specific item, and an authentication terminal connected to the authentication server via a network, and the authentication terminal includes: a target information obtainment unit operable to obtain target information that characterizes said object from the object, a location information obtainment unit operable to obtain location information showing a location where the object exists, and a sending unit operable to send the obtained target information and the obtained location information to the authentication server, and the authentication server includes: a receiving unit operable to receive the target information and the location information from the authentication terminal, a target information authentication unit operable to authenticate the object based on the received target information, a location information authentication unit operable to authenticate a location where the object exists based on the received location information, and an existence authentication unit operable to authenticate the existence of the object when the object is authenticated and the location information is authenticated.

As to a specific object (a person or an item owned by the person), an authentication terminal sends information typical of the object and information on the location where the object exists to an authentication server, the authentication server authenticates the validity of the object and the location based on the above-mentioned typical information and the location information, it is possible to grasp the fact that a specific correct object existed at a due location even from a remote location.

Also, in order to achieve the above-mentioned aim, the present invention can be realized as an authentication method in which the characteristic units of the above-mentioned authentication apparatus are regarded as steps, or a program for having a computer such as a personal computer execute these steps. And, it is also possible to distribute such a program using a recording medium such as a CD-ROM or a communication medium such as the Internet.

### FURTHER INFORMATION ABOUT TECHNICAL BACKGROUND TO THIS APPLICATION

filed , is incorporated herein by reference.

Japanese Patent application No. 2002-226532 filed Aug. 2, 2002.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing how various kinds of authentication are executed using the authentication apparatus when a delivery person of a delivery company distributes items in a first embodiment.

FIG. 2 is a diagram showing the appearance of the authentication apparatus in FIG. 1.

FIG. 3 is a block diagram showing the functional structure of the authentication apparatus.

FIG. 4 is a structural example of distributor's fingerprint data and the like which is stored in target information DB.

FIG. 5 is a structural example of a distribution data table which is stored in a storage unit.

FIG. 6 is a structural example of an authentication result data table to be registered in the storage unit when distribution is completed.

FIG. 7 is a flow chart showing the processing of the authentication apparatus.

FIG. 8 is a system structure diagram of the authentication system in a second embodiment.

FIG. 9 is a diagram showing the process of a business trip which is an example of a management target of the authentication system.

FIG. 10 is a structural diagram of a business trip schedule table indicating the employee's business trip schedule which is to be stored in the authentication server.

FIG. 11 is a structural diagram of a business trip result table which stores data showing the business trip result of an employee, the business trip result table is to be stored in an authentication server.

FIG. 12 is a communication sequence diagram between an authentication server when an employee goes to a business trip and au authentication apparatus.

FIG. 13 is a flow chart showing the process of arrival processing in an authentication terminal in FIG. 12.

FIG. 14 is a flow chart showing the process of authentication processing in FIG. 12.

FIG. 15 is a communication sequence diagram between an authentication server and an authentication terminal when the author of photographs with a copyright, a location where the photograph is taken using the authentication system.

FIG. 16 is a communication sequence diagram between the authentication server and the authentication terminal when authenticating the worker, the location and the like in the case where “a lock supervisor of a facility locks the facility when no worker is inside the facility” using the authentication system.

### DESCRIPTION OF THE PREFERRED EMBODIMENT(S)

Embodiments concerning the present invention will be explained below with reference to figures.

(First Embodiment)

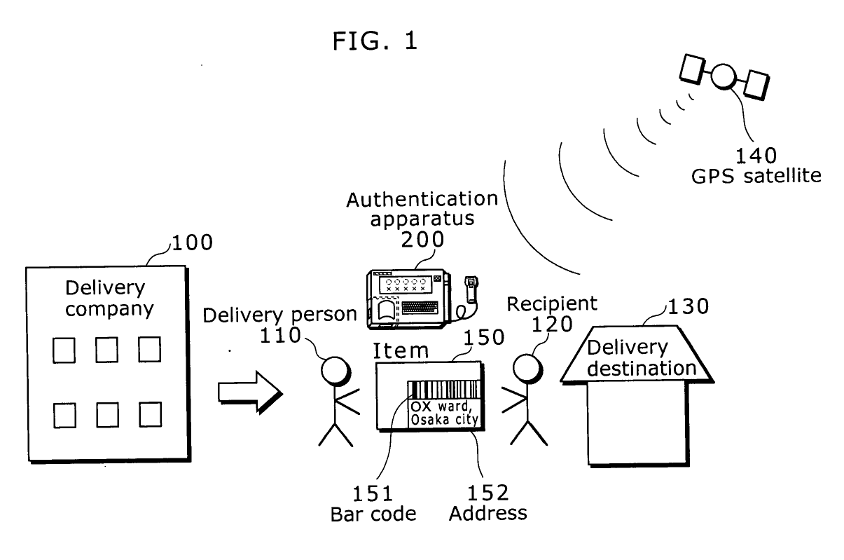

FIG. 1 is an example of this first embodiment, and a diagram showing the process of various kinds of authentications using an authentication apparatus 200 in the present embodiment when a delivery person in a delivery company distributes an item. FIG. 1 shows how a delivery person 110 of a delivery company 100 distributes an item 150 to a recipient 120 in a delivery destination 130. This time, the delivery person 110 performs an operation for authenticating a delivery person who used an authentication apparatus 200, an item, a delivery destination, delivery time and so on.

Here, “authentication” means proving that an operation is performed or a document is written by a correct operator based on a correct procedure and the like, the case where a specific person, an actual existence, an item was delivered correctly, no falsification of the contents and the like are proved is “authentication”.

More specifically, the fingerprint of the delivery person 110 is sampled using the authentication apparatus 200 when the delivery person 110 delivers the item 150 to the recipient 120, and a delivery person is authenticated when this fingerprint matches the fingerprint of the delivery person 110 registered in advance in the authentication apparatus 200. Further, a bar code 151 of the item 150 is scanned when an address 152 registered in advance in association with this bar code matches the location information obtained here via a GPS satellite 140, and an item and a delivery destination is authenticated. In addition, when the time obtained at the time of delivery (for example, obtained from an installed watch, a radiocontrolled clock and the like) among distribution time periods registered in advance in association with the above-mentioned bar code, distribution time is authenticated.

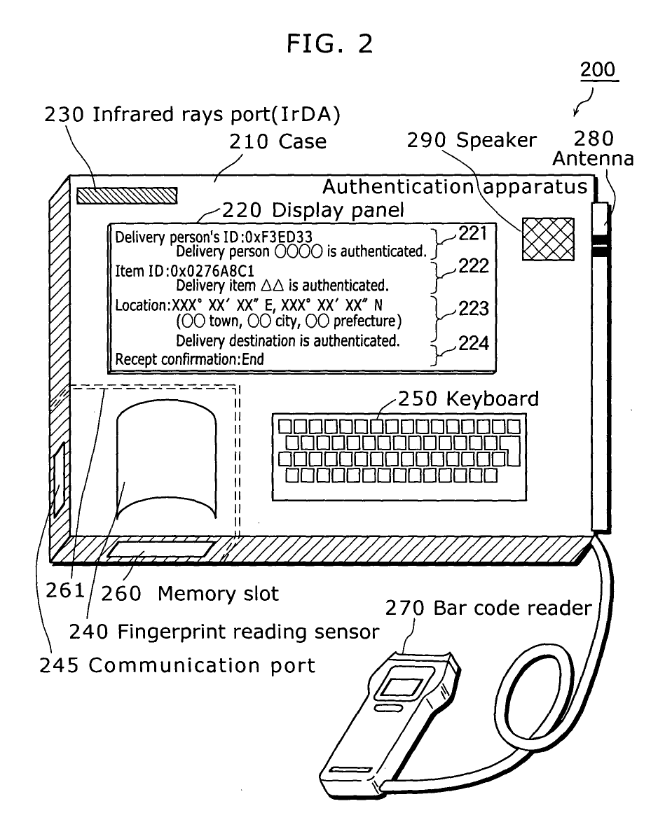

FIG. 2 is a diagram showing the appearance of the authentication apparatus 200 in the above-mentioned FIG. 1. The authentication apparatus 200 is a stand-alone type terminal which authenticates “a delivery person”, “an item”, “a delivery destination” and “delivery time” by an operation of the delivery person 110 when the item 150 is delivered, and a display panel 220, an infrared rays port 230, a fingerprint reading sensor 240, a keyboard 250, a memory slot 260, a bar code reader 270, an antenna 280 and the like are stored in the case 210.

The display panel 220, which can be a liquid crystal display, the contents of operation input received from an operator and the above-mentioned authentication result are displayed through the keyboard 250. FIG. 2 shows a display example of various kinds of authentication results, procedure circumstances and the like (221˜224).

The infrared rays port 230 is an input and output port capable of data communication with other information terminal such as a personal computer using infrared rays based on the IrDA standard and the like.

The fingerprint reading sensor 240 is a sensor of electrostatic capacity or optical type for scanning fingerprints, and the sensor scans a fingerprint of a finger put on the sensor. This fingerprint reading sensor 240 has a communication port 245 and the memory slot 260. Further, this fingerprint reading sensor 240 is detachable, and thus it is possible to become standard equipment of the authentication apparatus 200 or connect to a Personal Digital Assistants (PDA) such as other cellular phone via a communication cable which is connected to the communication port 245.

The communication port 245, which can be a serial communication port, is a communication interface port for sending data on the above-mentioned authentication from the fingerprint reading sensor 240 to a PDA other than the authentication apparatus 200.

The memory slot 260 is an interface device for reading or writing from or to a small storage medium such as an SD memory card. For example, the name and the address 152 of the recipient 120, the ID code of the delivery person 110 who is scheduled to deliver and scheduled delivery time period of respective one of ID codes of items which are to be delivered, are stored in advance in the small storage medium before delivery in a delivery company 500. Also, the ID code of the delivery person 110 and the fingerprint data of the delivery person are stored in a separately installed memory (not shown), registered or renewed by a supervisor and the like of the delivery company 100, and secured.

The bar code reader 270 is a device (such as an OCR type, a CCD type and the like) for the reading bar code 151 attached to the above-mentioned item 150 to be delivered.

The antenna 280 is an antenna for receiving location information or time information and the like which is sent from a key station of a PHS or a cellular phone (not shown) or the GPS satellite 140 and the like.

A speaker 290 generates an audible alarm when the holder of the authentication apparatus 200 (such as the above-mentioned operator 110) nears to the previously set range (for example, within a radius of 50 m of the above-mentioned delivery destination 150).

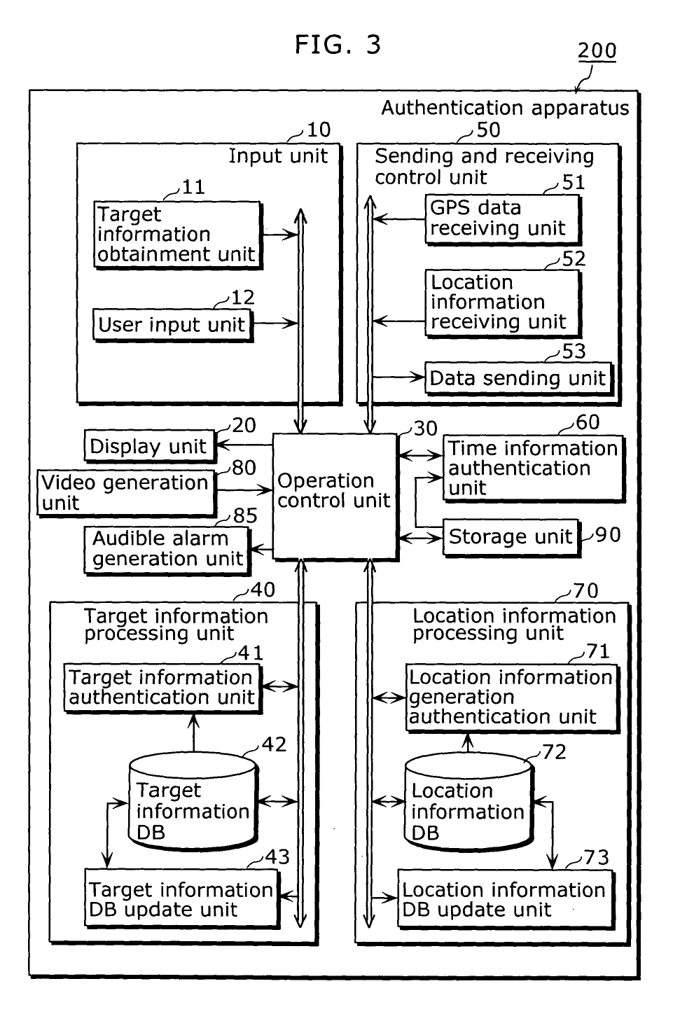

FIG. 3 is a block diagram showing the functional structure of the authentication apparatus 200 in the above-mentioned FIG. 2. As shown in FIG. 3, the authentication apparatus 200 comprises an input unit 10, a display unit 20, an operation control unit 30, a target information processing unit 40, a sending and receiving control unit 50, a time information authentication unit 60, a location information processing unit 70, a video generation unit 80, an audible alarm generation unit 85 and a storage unit 90.

The input unit 10 is a part that obtains data necessary for this authentication apparatus 200 and receives operation input from an operator, and the input unit 10 comprises a target data obtainment unit 11 and a user input unit 12.

The target data obtainment unit 11 includes the fingerprint reading sensor 240, the bar code reader 270 in the above-mentioned FIG. 2, and the target data obtainment unit 11 obtains information (called “target information” from here) necessary for differentiating respective one of these things to be authentication targets from each other (for example, a person or an item) and sends the target information to the operation control unit 30.

Here, target information in the case of authenticating a person includes an ID code or a password inputted by an operator, fingerprint data inputted through the fingerprint reading sensor 240 and the like, voice print data, picture data showing facial features, iris data, DNA data and so on. Authentication can be performed using one of those target information data or authentication with a higher accuracy can be performed when using two or more target information data in combination. On the other hand, target information in the case of authenticating an item includes an ID code (including a bar code), picture data showing the feature of an item and so on.

The user input unit 12 is a part corresponding to the keyboard 250 in the above-mentioned FIG. 2, and the user input unit 12 receives a keyboard input of an ID code, a password and the like from an operator as the need arises.

The display unit 20 includes the display panel 220 in the above-mentioned FIG. 2 and displays the contents inputted through the user input unit 12 or an authentication result.

The operation control unit 30 is, for example, a micro computer that has a ROM or a RAM, and the operation control unit 30 controls the whole authentication apparatus 200. Further, the operation control unit 30 receives target information from the target information obtainment unit 11 and sends the target information to the target information processing unit 40. In this case, the operation control unit 30 stores the received target information as data base in the storage unit 90 as the need arises. In addition, the operation control unit 30 has an integral clock capable of checking time, and the operation control unit 30 gives time information showing the time upon request from a time information obtainment unit 61. Also, the operation control unit 30 compares the address of the previously set delivery destination with the present address with a certain frequency (for example, at a rate of once per 30 seconds), when the present address nears to a predetermined range (for example, within a radius of 50 m of the above-mentioned delivery destination 150), the operation control unit 30 generates an alarm generation signal, and sends the alarm to the audible alarm generation unit 85. Also, the operation control unit 30 may have a built-in radiocontrolled clock and send time information according to the clock.

The target information processing unit 40 performs authentication processing as to target information received via the operation control unit 30, has the function that updates target information stored in the target information DB 42, and comprises a target information authentication unit 41, the target information DB 42 and a target information DB update unit 43.

The target information authentication unit 41 checks target information received from the operation control unit 30 against information stored in advance in the target information DB 42, makes a judgment of “matched” or “not matched”, notifies the operation control unit 30 of the result. For example, the inputted delivery person's fingerprint data is checked against fingerprint data stored in advance in the target information DB 42 in the target information obtainment unit 11, and the target information authentication unit 41 notifies the operation control unit 30 of “a delivery person ID” corresponding to the fingerprint data when there is a matching fingerprint, while the target information authentication unit 41 notifies the operation control unit 30 of “no matching person”. It is possible to input data except the delivery person's fingerprint data, for example, an ID code, a password, voice print data, data on a facial feature, iris data, DNA data and the like through the target information obtainment unit 11, check those data against previously registered data, and notify the operation control unit 30 of the result.

The target information DB 42 is, for example, a RAM or a hard disc, and the target information DB 42 stores an ID code or a password for differentiating a person or an item from each other, fingerprint data, voice print data, data on a facial feature, iris data, DNA data and so on. Registration or update of the above-mentioned data should be performed by a specific person, and the security should be secured.

The target information DB update unit 43 registers or updates target information stored in the target information DB 42 on an instruction from the operation control unit 30.

The sending and receiving control unit 50 has a function that communicates with a GPS satellite, a PHS, a cellular phone so as to obtain location information and time information that are necessary for determining the present location and the present time, and the sending and receiving control unit 50 has a GPS data receiving unit 51, a location information receiving unit 52, and a data receiving unit 53.

The GPS data receiving unit 51 receives location information and time information from a GPS satellite 550. The location information receiving unit 52 receives location information from a base station of a PHS or a cellular phone, location information from a beacon and the like. The data receiving unit 53 is a part corresponding to the infrared rays port 230 in the above-mentioned FIG. 2 and a sending control circuit in a PHS, a cellular phone and the like, and the data receiving unit 53 sends the data of authentication result and the like received from the operation control unit 30 to a PC or other portable information terminal and the like.

The time information authentication unit 60 checks time information received from the operation control unit 30 against information stored in advance in the storage unit 90 (for example, the above-mentioned delivery time period), and notifies the operation control unit 30 of the result. The time information authentication unit 60 checks, for example, time information obtained via the GPS data receiving unit 51 against delivery time period stored in advance in the storage unit 90, notifies the operation control unit 30 of “delivery on time” when the time shown by time information is included in one of those delivery time periods or “delivery not on time” when the time is not included.

The location information processing unit 70 has a function that authenticates a location by checking location information received via the sending and receiving control unit 50 and the operation control unit 30 against data stored in advance in a location information DB 72, and the location information processing unit 70 comprises a location information generation authentication unit 71, a location information DB 72 and a location information DB update unit 73.

The location information generation authentication unit 71 transforms location information received via the operation control unit 30 to the one that matches location information stored in advance in the location information DB 72 (for example, transforms the latitude and longitude of the received time information to the real address), checks the changed location information with location information stored in advance in a location information DB, and makes a judgment of “matched” or “not matched”. The judgment result is notified to the operation control unit 30.

The location information DB 72 is, for example, a hard disc, a RAM and the like, and the location information DB 72 stores data for transforming the above-mentioned information. For example, it is a data base for transforming location information represented by the latitude and longitude to the real address (for example, ΔΔ city ◯◯ prefecture) (or the converse transformation).

The location information DB update unit 73 updates the contents of the location information DB 72 according to the instruction of the operation control unit 30.

The video generation unit 80 stores the videotaped data obtained by an operator (such as the appearance of the item to be delivered or its ID code), the reading result of a bar code and the like.

The audible alarm generation unit 85 includes the above-mentioned speaker 290, synthesizes the predetermined beeps and outputs an audible alarm from a speaker when receiving an alarm generation signal from the operation control unit 30.

The storage unit 90 is the memory slot 260 in the above-mentioned FIG. 2, a compact storage medium, a RAM and the like, and the storage unit 90 stores the recipient's name and address, an ID code of the scheduled delivery person and the scheduled delivery time period of respective one of items to be delivered that are registered before delivery as mentioned above, an ID of a delivery person, a delivery location, delivery date and time of respective one of items to be delivered that are registered as an authentication result and the like. The above-mentioned compact storage medium can be a flexible disc and the like other than an arbitrary memory card represented by an SD card, a multimedia card and so on.

Note that data to be stored may be encrypted and the storage medium may be an SDX that is encrypted.

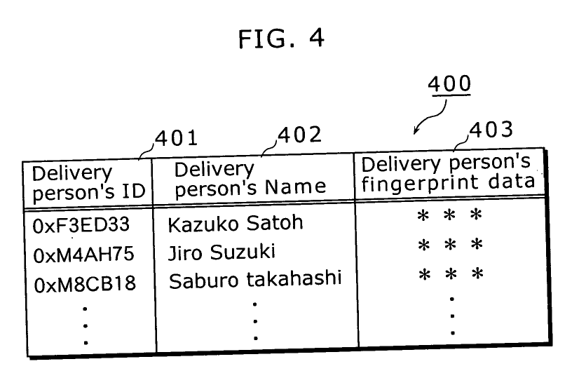

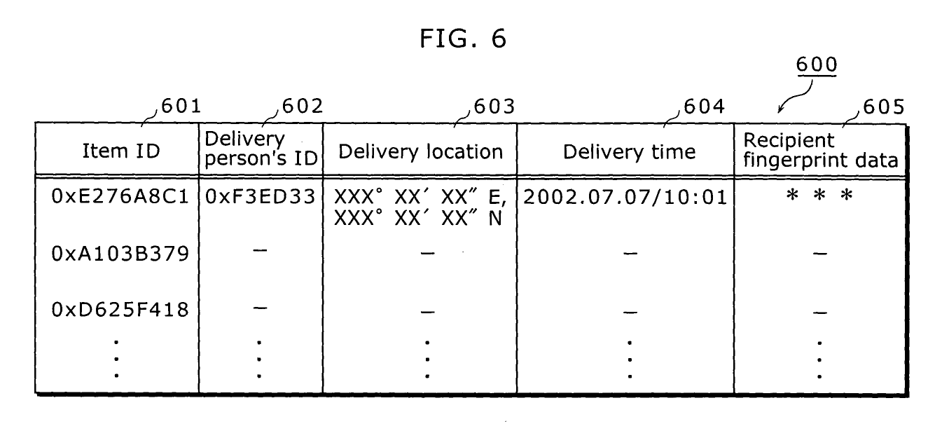

FIG. 4˜FIG. 6 are structural examples of data stored in the target information DB 42 or the storage unit 90 in the above-mentioned FIG. 3.

FIG. 4 is a structural example of delivery person's fingerprint data and so on to be stored in the target information DB 42. As shown in FIG. 4, a delivery person's fingerprint data 403 is associated with a delivery person's ID 401 and a delivery person's name 402 and stored in advance (before starting delivery) in the target information DB 42. Note that only a few staff members in charge out of staff members are allowed to register or update this fingerprint data and any delivery person is not allowed to register or update this fingerprint data.

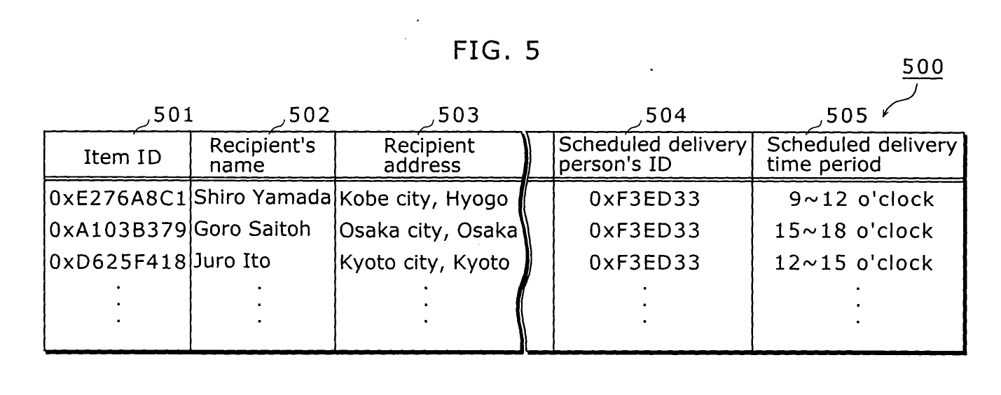

FIG. 5 is a structural example of a data table for delivery to be stored in the storage unit 90. Here, “a data table for delivery” means a table into which information on undelivered items is integrated, and the data table for delivery is registered before starting delivery on the date of delivery. As shown in FIG. 5, a recipient's name 502, a recipient's address 503 and a scheduled delivery time period 504 for each item ID 501 are stored in advance (before starting delivery) in the storage unit 90 of data table for a delivery 500. Year, month and day may also be registered in the above-mentioned scheduled delivery time period 505. Also, only staff members in charge are allowed to register or update these delivery data.

FIG. 6 is a structural example of an authentication result data table when finishing delivery registered in the storage unit 90. Here, “authentication result data table” is a table into which various kinds of information necessary for authentication and an authentication result are integrated before delivering an item, and “authentication result data table” is stored when finishing delivery. As shown in FIG. 6, a delivery person's ID 602, a delivery location 603, the delivery date and time 504, and the recipient's fingerprint data 605 for each item ID 601 are stored in the storage unit 90 as the authentication result data table 600 when finishing delivery. Here, a delivery person ID 602 is a delivery person's ID code stored when the delivery person's fingerprint data matches the previously registered fingerprint data at the time of delivery. Also, a delivery location 603 shown with the latitude and longitude and a delivery time and date 604 are automatically obtained from a GPS satellite and the like and stored when the item ID is read by the bar code reader 270. Recipient's fingerprint data 605 is obtained from a recipient as a confirmation indicating the delivery of the item is completed.

Next, the processing flow of the authentication apparatus 200 when performing various kinds of authentications using the authentication apparatus 200 in the delivery person 110 of the above-mentioned delivery company 100 delivers the item 150 will be explained.

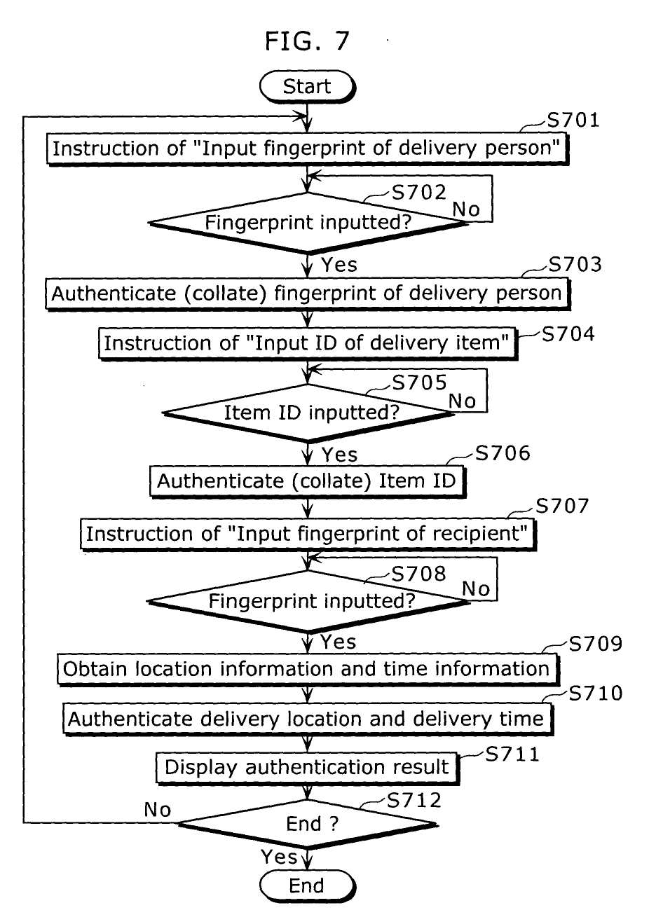

FIG. 7 is a flow chart showing the processing of this authentication apparatus 200.

First, the operation control unit 30 has display unit 20 display, for example, “Input a delivery person's fingerprint” (S701), and waits for input of a fingerprint from a delivery person (S702). When a fingerprint is inputted, the operation control unit 30 refers to the target information DB 42 and instructs the target information authentication unit 41 to judge whether the delivery person concerned is a right delivery person or not. In this case, when the delivery person is judged to be right, the delivery person concerned is “authenticated” (S703).

Next, the operation control unit 30 has a display unit 20 display, for example, “Input a bar code of an item” (S704), and waits for an input of a bar code attached to an item (S705). When a bar code is inputted, the operation control unit 30 refers to the target information DB 42 and instructs the target information authentication unit 41 to judge whether the item concerned is an item to be delivered. When the item is judged to be the item to be delivered, the item concerned is “authenticated” (S706).

Further, the operation control unit 30 has a display unit 20 display, for example, “Input a recipient's fingerprint” (S707), and waits for an input of a fingerprint from a recipient (S708). On inputting a fingerprint, the operation control unit 30 instructs the sending and receiving control unit 50 to obtain location information and time information (S709). When location information and time information are obtained, the operation control unit 30 instructs the location information processing unit 70 and the time information authentication unit 62 to judge whether the delivery information and delivery time are right or not (S710).

Further, the operation control unit 30 sends the above-mentioned authentication result to the display unit 20 (S711).

As mentioned above, it is possible to authenticate “a specific object (a person or a thing) existing at a specific location and an item is delivered right” because the authentication apparatus 200 of this embodiment checks the dynamically obtained data against data registered in advance and which is secured.

Note that authentication order is arbitrary, while the authentication in the above-mentioned embodiment is performed in the following order: first, “a delivery person's fingerprint”, second, “an item ID”, and the last, “a recipient's fingerprint”. Also, an example of using fingerprint data as target information for authenticating a person is shown, but target information is not limited to fingerprint data, voice print data, picture data showing the facial feature, iris data and the like can also be used as mentioned above.

Also, the authentication method by the target information authentication unit 41 and the location information generation authentication unit 71 in the above-mentioned embodiment can be a general authentication method. For example, an authentication execution code made by a specific authentication organization can also be used. Also, it is possible to maintain authentication accuracy (for example, avoid a “masquerade” case) by dynamically controlling an authentication code of each terminal (each authentication apparatus in this case).

Further, target information used for authentication of the item 150 in the above-mentioned embodiment is not limited to the bar code 151 and it can be arbitrary information for authenticating an item (such as video data of an appearance). This time, it is also possible to confirm that a tag is attached to item S in the video generation unit 80 as a picture. Consequently, it becomes possible to confirm that the tag does not come off from item S.

It is also possible to authenticate item S directly from the picture of item S. That item S is surely delivered to the location is proved by authentication apparatus 1 authenticating the location and item S when item S is delivered to Mr. B.

For example, when considering the case where the above-mentioned Mr. A requested delivery company D for delivering Mr. B the item S of importance, company D can prove that “item S is sent to Mr. B” by performing authentications of Mr. B and item S. Thus, a false statement by company D (making a report of “delivered” although company D did not deliver item S in fact) or “masquerade” (a person other than Mr. B receiving item S instead of Mr. B) can be avoided, plus, company D can prove that the delivery of a package was surely finished. This invention is applicable in proof of delivery mail or in the case where other arbitrary “specific person” and “specific item” are authenticated.

(Second Embodiment)

An authentication system 300 composed via a net work will be explained in this second embodiment, while the authentication apparatus 200 of a stand-alone type is explained in the above-mentioned first embodiment. This authentication system 300 is a system in which the authentication server 310 that receives data necessary for authenticating fingerprint data, location information and the like from the authentication apparatus 201 performs various kinds of authentication (for example, authentication and the like such as “a visitor” who visited on a business trip, “a visiting destination”, “a visiting time” and the like) based on these data.

Units different from the above-mentioned embodiment 1 will be focused on below, the same code are assigned to the same units, and explanation for those units are omitted.

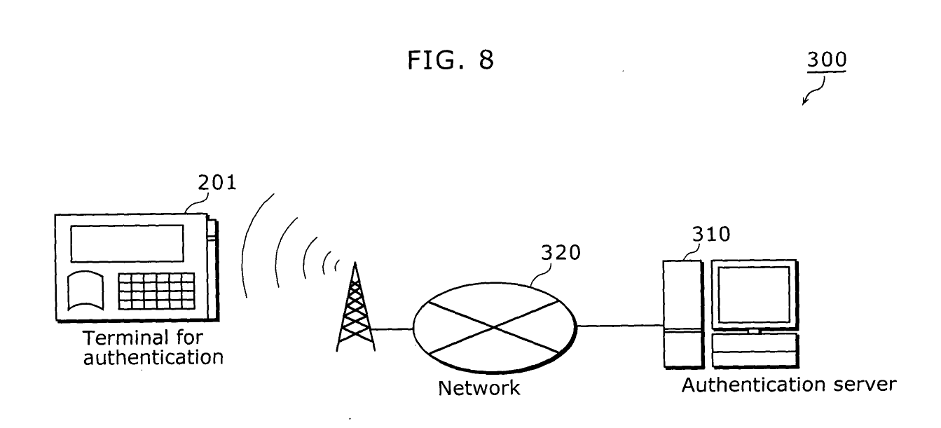

FIG. 8 is a system structure of the authentication system 300 in this embodiment. As shown in FIG. 8, this system 300 sends target information from the authentication apparatus 201 to the authentication server 310 via the network 320 such as the Internet, and the authentication server 310 authenticates the target information based on the received target information.

The authentication apparatus 201 is a terminal for sending target information to the authentication server 310, and there is no need to have the target information processing unit 40, the time information authentication unit 60 and the location information processing unit 70 in the authentication apparatus 200 while the authentication apparatus 201 has the same function as the authentication apparatus 200 in the above-mentioned embodiment 1.

In other words, the authentication server 310 is a server that receives target information from the authentication apparatus 201, and performs various kinds of authentications based on this target information (such as a personal computer and the like that has a communication function and a server function), and the authentication server 310 has the operation control unit 30, the target information processing unit 40, the time information authentication unit 60 and the location information processing unit 70 (not shown) in the authentication apparatus 200.

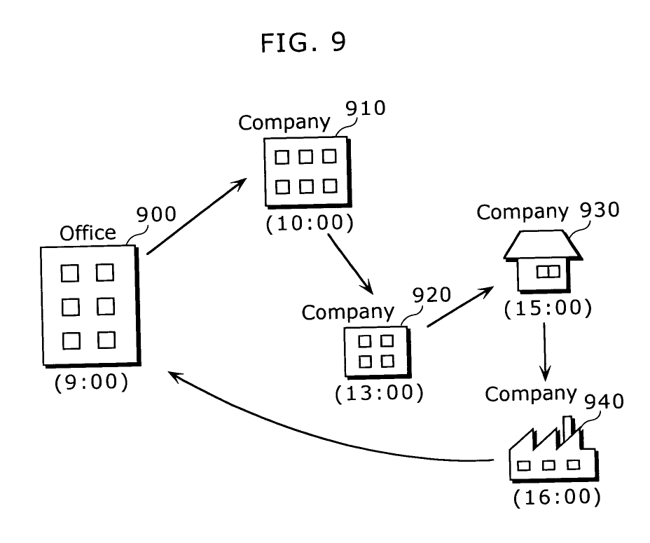

FIG. 9 is a diagram showing how the business trip was going on as an example of control target by the authentication system 300, and FIG. 9 is a diagram showing a scheduled route and a scheduled visiting time in the business trip (which are shown in FIG. 9). As shown in FIG. 9, a company staff member 901 visits a company 910 at 10 o'clock, and then visits a company 920 at 13 o'clock, a company 930 at 15 o'clock, a company 940 at 16 o'clock in order. At that time, a company staff member 901 sends fingerprint data, location information and the like to the authentication server 310 when arriving at respective visiting companies. Consequently, a supervisor 902 in an office 900 authenticates “a visitor”, “a visiting destination” and “visiting time”.

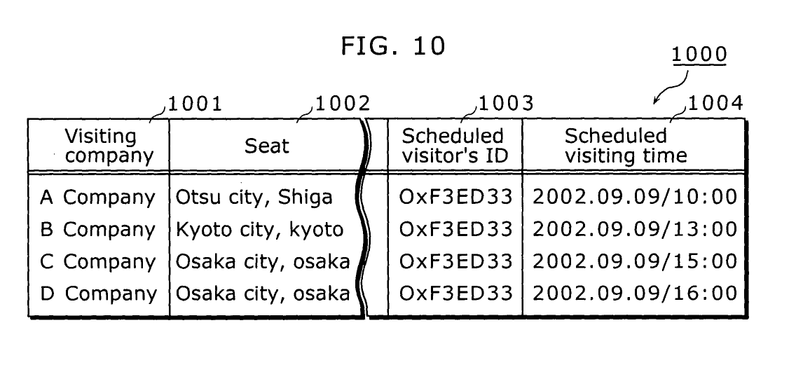

FIG. 10 is a structural example of a table into which data showing the business trip schedule of the company staff member 901 (“a business trip schedule table” below). As shown in FIG. 10, a company address 1002, a scheduled visitor's ID 1003 and a scheduled visiting time 1004 for each visiting destination company name 1001 are stored in this business trip schedule table 1000. This business trip schedule table is stored in a storage unit 90 of an authentication server 310 before the business trip of a company staff member 901.

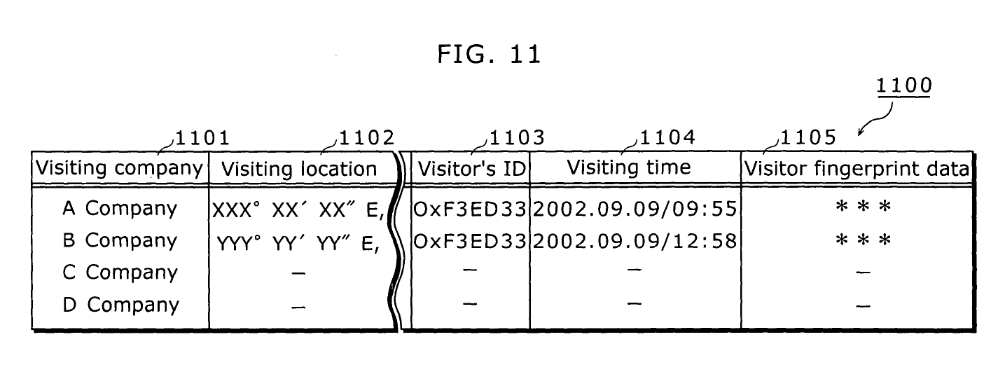

FIG. 11 is a structural example of a table into which data showing the business trip result of a company staff member 901 (“a business trip result table” below). As shown in FIG. 11, dada showing a visiting location 1102, a visitor's ID 1103, a visiting date and time 1104 and a visitor's fingerprint data 1105 of respective one of visiting company 1101 in this business trip table 100 are registered. Each data of this business trip result table is stored in a storage unit 90 of an authentication server 310 after a company staff member 901 (or an operator of an authentication terminal for 201) arrives at each business trip (after receiving target information from an authentication apparatus 201 and authenticating the target information). “-” in FIG. 11 indicates that the company staff member 901 does not arrive at the company and the “-” is unset data.

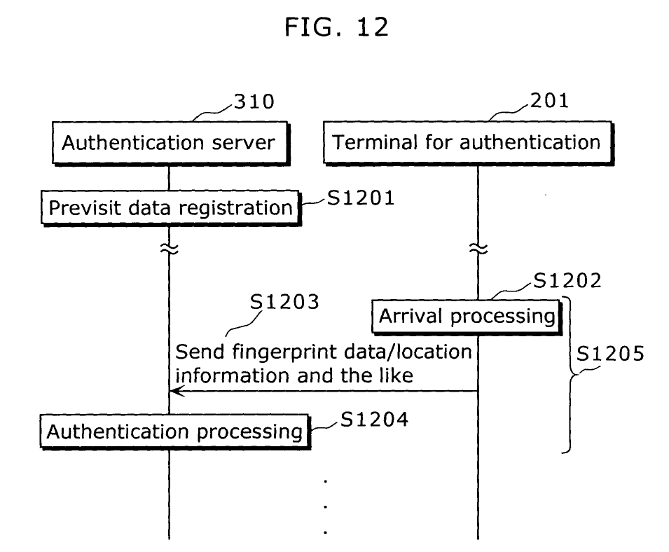

FIG. 12 is a communication sequence diagram between an authentication server 310 and an authentication apparatus 201 when a company staff member 901 makes a business trip.

First, necessary data is registered in business trip schedule table 1000 before a company staff member 901 makes a business trip (S1201). Next, a company staff member 901 sends his or her “fingerprint data”, obtained “location information” and “time information” to an authentication server 310 as arrival processing when arriving at company of the business trip destination (S1202, S1203). Consequently, an authentication server 310 authenticates “a visitor”, “a visiting destination” and “a visiting time” as authentication processing based on the received above-mentioned information and registers the predetermined data in a business trip result table 1100 (S1204).

The above-mentioned processing is repeated each time a company staff member 901 arrives at respective one of companies according to the schedule (S1205).

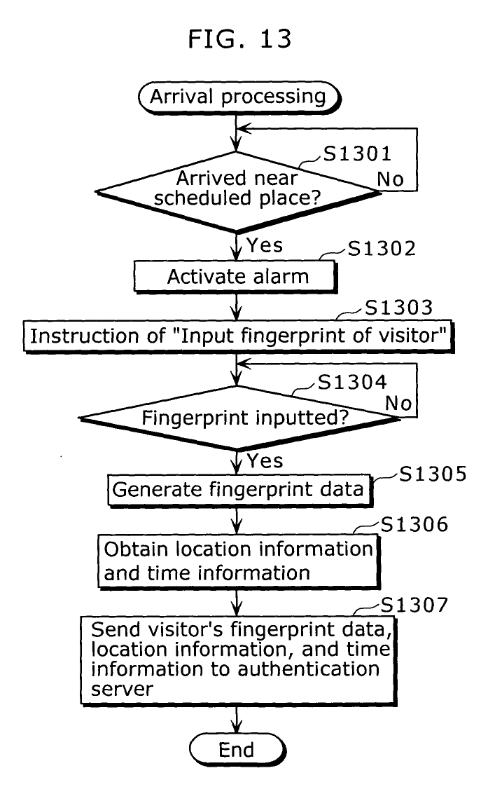

FIG. 13 is a flow chart showing the arrival processing in an authentication terminal in the above-mentioned FIG. 12.

First, operation control unit 30 in an authentication terminal 201 compares the previously set visiting destination address and the present address at a fixed frequency (for example, at a rate of once in 30 seconds), when the present address nears to the previously set visiting destination address (for example, within a radius of 50 m from a visiting destination) (S1301:Yes), the operation control unit 30 generates an alarm generation signal and sends an audible alarm generation unit 85. Consequently, an audible alarm generation unit 85 generates an audible alarm (S1302)

Next, an operation control unit 30 has a display 20 display, for example, “Input a visitor's fingerprint” (S1303), and waits for a fingerprint input from an operator (S1304). When a fingerprint is inputted, an operation control unit 30 generates fingerprint data (S1305).

After this, an operation control unit 30 instructs a sending and receiving control unit 50 to obtain location information and time information (S1306). When location information and time information is obtained, an operation control unit 30 sends the above-mentioned fingerprint data, location information and time information to an authentication server 310 (S1307).

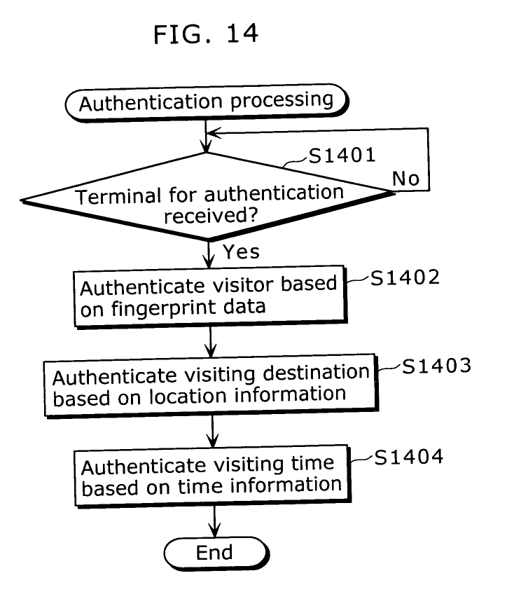

FIG. 14 is a flow chart showing the authentication processing 1204 in the above-mentioned FIG. 12.

First, when an operation control unit 30 of an authentication server 310 receives visitor's fingerprint data, location information and time information from an authentication terminal 201 (S1401), and authenticates the visitor, the visiting destination, and the visiting time based on a visitor's fingerprint data stored in advance in the target information DB 42, an address 1002 stored in a storage unit 90 and a scheduled visiting date and time 1004 (S1402˜S1404). Note that the authentication order of each processing of the above-mentioned S1402˜S1404 is not limited to the one mentioned in FIG. 14, it is arbitrary.

Also, this authentication system 300 is not limited to the above-mentioned business trip control applicable when authenticating an author of a publication and a staff member in lock control.

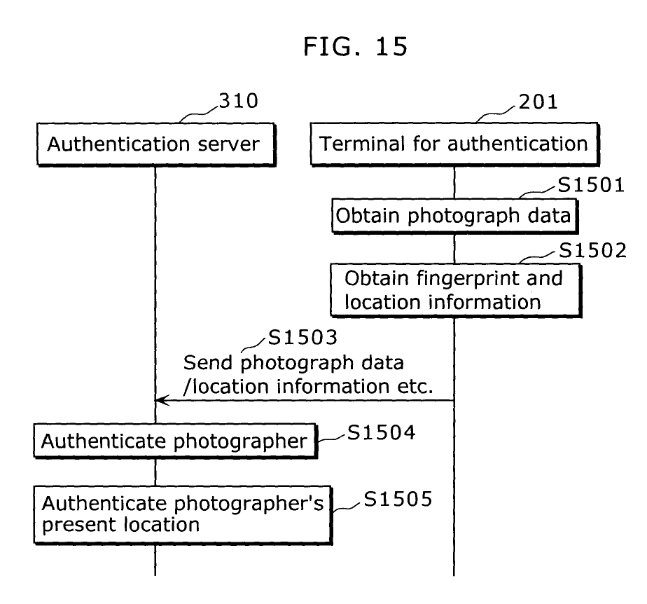

FIG. 15 is a communication sequence diagram between an authentication server 310 and an authentication terminal 201 when authenticating an author in a photograph publication, video location and the like.

First, when reading photograph data by a photographer's operation (S1501), an authentication terminal 201 sends photo data, fingerprint data, location information on a location where the photograph is taken and time information on when the photograph is taken obtained in the same manner as FIG. 13 (“photographer” is employed in stead of “visitor”) to an authentication server 310 (S1502, S1503).

Next, an operation control unit 30 of an authentication server 310 receives photograph data, fingerprint data, location information and the like from an authentication terminal 201, and authenticates a photographer based on the photographer's fingerprint data registered in advance (S1504). Further, an operation control unit 30 of an authentication server 310 authenticates the photographed location (the present location at which a photographer stands) based on the information showing the previously registered location where photographs are scheduled to be taken (S1505).

When it is possible to obtain information that makes it possible to identify objects from the above-mentioned photograph target like the above-mentioned bar code, it is possible to send this information to an authentication server 310 and authenticate the information with a higher degree of accuracy.

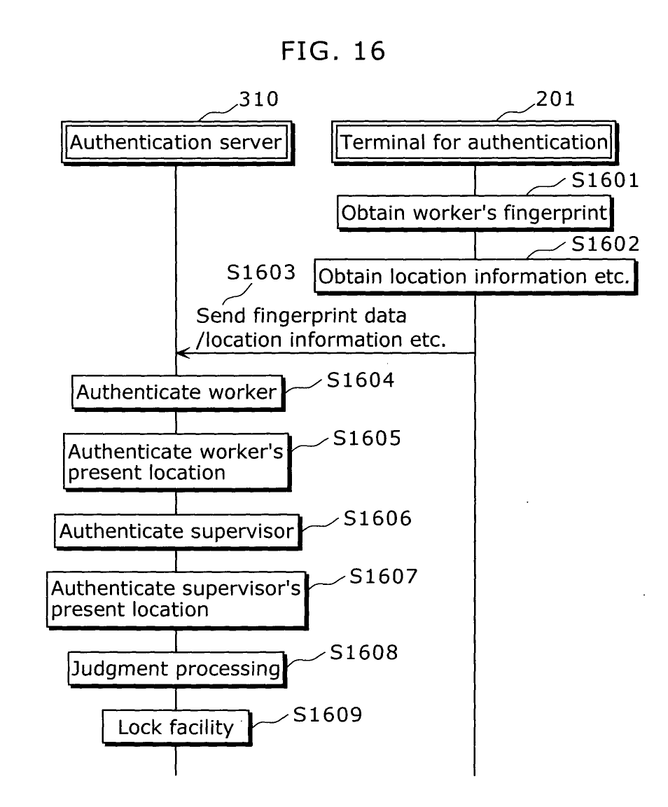

FIG. 16 is a communication sequence diagram between an authentication server 310 and an authentication terminal 201 when authenticating a worker, the location and the like when “a lock supervisor of a facility locks in the case where no worker is inside the facility using this authentication system 300. This case, an operator holds an authentication terminal 201, and an authentication server 310 is equipped in a control center (not shown). Plus, it is allowed to lock the door of the facility only when the lock supervisor is inside the control center.

First, an authentication terminal 201 receives an input of a worker (S1601) and obtains location information and time information (S1602) when a worker leaves the facility. Further, an authentication terminal 201 sends the obtained fingerprint data, location information and the like to an authentication server 310 (S1603).

Next, an authentication server 310 inside the control center authenticates the fact that no worker is inside the facility based on the received worker's fingerprint data, location information and the like (S1604, S1605). Further, an authentication server 310 obtains fingerprint data from a supervisor, location information and time information, and authenticates the fact that a supervisor is inside the control center (S1606, S1607). After confirming that no worker is inside the facility by the above authentications (S1608), and an authentication server 310 becomes possible to lock the door of a facility (S1609).

The above-mentioned system can perform the same lock control by repeating the same authentication of each worker even when there are a plurality of workers.

Up to this point, by using an authentication system concerning this embodiment, it becomes possible to build a security system with a higher accuracy in a remote location because a target object, the location information and the like is sent from an authentication terminal to an authentication server via a network.

In order to accelerate an authentication processing inside the authentication apparatus, it is possible to use Logical Unit Table (LUT) other than the above-mentioned target information DB and location information DB. By using this, it becomes possible to reduce data inputs necessary for authentication.

It is also possible to improve the authentication accuracy by superimposing plural kinds of authentications. For example, when the error rates of an authentication apparatus are a factor of 1000, it is possible to improve the error rates to a factor of 1000000 by authenticating using two authentication apparatuses.

Like a plurality of authentication apparatuses mentioned above, it is possible to improve the authentication accuracy by using a plurality of data for authentication of an authentication target, and a person.

Further, only when these two authentications are approved, it is possible to use authentication results as a verification tag when delivering an item (or delivering an item) by making these authentications effective. Function by using a plurality of data for authentication is not limited to the one mentioned above, a plurality of data for authentication can be used so as to realize an arbitrary function.

Also, other authentication apparatus or a server can authenticate the authentication function of a specific authentication apparatus.

As an authentication means of an authentication apparatus, a cryptographic technology such as a secret key, a public key, cryptography based on the difficulty of an inverse operation of one-way function and a DNA authentication by sweat and so on can be used.

When there are plural kinds of authentication methods, an authentication server can dynamically select an authentication method according to the communication environment, the performance of an apparatus and the like, and notifies the authentication terminal of the authentication method.

Further, when the password of an operator and the like leaks to an outsider and the like, it is possible to have an operator present a warning such as “There is a possibility of password leakage”. Also, it is possible to control the usage of the apparatus concerned to stop.

What is claimed is:

1. An authentication apparatus for authenticating a specific object as a target, comprising:
a target information obtainment unit operable to obtain first target information that characterizes the object from said object;
a target information authentication unit operable to authenticate the object based on the obtained first target information;
a location information obtainment unit operable to obtain location information showing a location where the object exists; and
a location information addition unit operable to associate the obtained location information with the first target information concerning the object who is authenticated.

2. An authentication apparatus for authenticating validity and an existence of a specific object as a target, comprising:
a target information obtainment unit operable to obtain target information that characterizes the object;
a location information obtainment unit operable to obtain location information showing a location where the object exists;
a target information authentication unit operable to authenticate the object based on the obtained target information;
a location information authentication unit operable to authenticate the location where the object exists based on the obtained location information; and
an existence authentication unit operable to authenticate the existence of the object when the object is authenticated and the location information is authenticated.

3. The authentication apparatus according to claim 1 or claim 2, further comprising:
a first storage unit operable to store second target information for authenticating the specific object in advance; and
wherein, when the first target information concerning the specific object is obtained, the target information authentication unit reads out the second target information concerning the object from the first storage unit and checks the second target information concerned and the first target information obtained, and the target information authentication unit authenticates the specific object when the first target information matches the second target information.

4. The authentication apparatus according to claim 3,
wherein the specific object is a specific person.

5. The authentication apparatus according to claim 4,
wherein the target information obtainment unit obtains at least a piece of information as the first target information out of target information showing a password, biometrix authentication information, a fingerprint, a voice print, a facial appearance, a retina, a shape of a palm, handwriting, a vein pattern on a back of a hand and an iris capable of identifying the specific person.

6. The authentication apparatus according to claim 3,
wherein the specific object is an item which is owned by a specific person or the person concerned.

7. The authentication apparatus according to claim 6,
wherein the target information obtainment unit obtains at least a piece of information as the first target information out of information showing a password, biometrix authentication information, a fingerprint, a voice print, a facial appearance, a retina, a shape of a palm, handwriting, a vein pattern on a back of a hand and an iris capable of identifying the specific person, and obtain at least a piece of information out of information showing an identification code that characterizes an item and an appearance of the item.

8. The authentication apparatus according to claim 3,
wherein the location information obtainment unit obtains location information of a location where the object exists using a Global Positioning System.

9. The authentication apparatus according to claim 3,
wherein the location information obtainment unit obtains location information of a location where the object exists from a base station of a Personal Handyphone System or a cellular phone system.

10. The authentication apparatus according to claim 3,
wherein the location information obtainment unit further obtains time information showing time when the object exists from a radiocontrolled clock system.

11. The authentication apparatus according to claim 3, further comprising a built-in clock capable of checking predetermined reference time or standard time, and
wherein a location information obtainment unit further obtains time information showing time when the object exists from the clock.

12. The authentication apparatus according to claim 11, further comprising:
a time information authentication unit operable to authenticate time when the object exists based on the obtained time information; and
wherein the existence authentication unit further authenticates the object existing at the authenticated time.

13. The authentication apparatus according to claim 12, further comprising:
a second storage unit operable to store in advance second target information that characterizes the specific object, and location information and time information showing a location and time after a transfer in the case where the object concerned is transferred according to a predetermined schedule; and
wherein the target information authentication unit reads out the second target information concerning the specific object from the second storage unit, checks the read-out second target information and the obtained first target information, and authenticates the specific object when the first target information matches the second target information,
the location information authentication unit reads out the location information after a transfer concerning the specific object from the second storage unit, checks the read-out location information and the obtained location information, and authenticates a location where the specific object exists in the case where the read-out location information matches the obtained location information; and
the time information authentication unit reads out time information concerning time after a transfer concerning the specific object, compares the read-out time information and the obtained time information, and authenticates time when the specific object exists in the case where the two pieces of time information belong to the same time period.

14. An authentication system comprising:
an authentication server for authenticating validity and an existence of an object as a target, the object being at least one of a specific person and a specific item; and
an authentication terminal connected to the authentication server via a network; and
wherein the authentication terminal includes:
a target information obtainment unit operable to obtain target information that characterizes said object from the object,
a location information obtainment unit operable to obtain location information showing a location where the object exists, and
a sending unit operable to send the obtained target information and the obtained location information to the authentication server, and
the authentication server includes:
a receiving unit operable to receive the target information and the location information from the authentication terminal,
a target information authentication unit operable to authenticate the object based on the received target information,
a location information authentication unit operable to authenticate a location where the object exists based on the received location information, and
an existence authentication unit operable to authenticate the existence of the object when the object is authenticated and the location information is authenticated.

15. The authentication system according to claim 14,
wherein the target information obtainment unit of the authentication terminal obtains at least a piece of information out of information showing a password, biometrix authentication information, a fingerprint, a voice print, a facial appearance, a retina, a shape of a palm, handwriting, a vein pattern on a back of a hand and an iris capable of identifying the specific person, as the target information and obtains at least a piece of information out of information showing identification code capable of identifying an item and an appearance of the item.

16. The authentication system according to claim 14,
wherein the location information obtainment unit of the authentication terminal obtains location information of a location where the object exists from a base station of a Personal Handyphone System or of a cellular phone system.

17. The authentication system according to claim 14,
wherein the location information obtainment unit of the authentication terminal obtains location information of a location where the object exists using a Global Positioning System.

18. The authentication system according to claim 17,
wherein the authentication terminal further includes a time information obtainment unit operable to obtain time information showing time when the object exists,
the sending unit sends the obtained time information to the authentication server,
the receiving unit of the authentication server further receives time information from the authentication terminal,
the authentication server further includes a time information authentication unit operable to authenticate time when the object exists based on the received time information, and
the existence authentication unit of the authentication server further authenticates the object existing at the authenticated time.

19. The authentication system according to claim 18,
wherein the time information authentication unit of the authentication server further obtains time information from a radiocontrolled system, and authenticates time when the object exists based on the time information concerned and the received time information.

20. The authentication system according to claim 18,
wherein the authentication server has a built-in clock capable of checking predetermined reference time or standard time, and
the time information authentication unit further authenticates time when the object exists based on the time information of the built-in clock and the received time information.

21. The authentication system according to claim 20,
wherein the authentication server further includes:
a storage unit operable to store in advance location information and time information showing a location after a transfer and time in the case where the object concerned is transferred according to a predetermined schedule based on target information that characterizes the specific object, and
in the authentication server,
the target information authentication unit reads out target information concerning the specific object from the storage unit, checks the read-out target information concerned and the received target information, and authenticates the specific object being right when the read-out target information matches the received target information,
the location information authentication unit reads out the location information after a transfer concerning the specific object from the storage unit, checks the read-out location information concerned and the received location information, and authenticates time when the specific object exists in the case where the two pieces of time information belong to the same time period, and
the time information authentication unit reads out time information after a transfer concerning the specific object from the storage unit, compares the read-out time information concerned and the received time information, and authenticates a location where the specific object exists in the case where the two pieces of time information belong to the same time period.

22. The authentication system according to claim 21,
wherein the sending unit of the authentication terminal further adds information that makes it possible to identify an authentication terminal to the target information and the location information and sends the information to the authentication server, and
the receiving unit of the authentication server further checks whether information that makes it possible to identify the received authentication terminal or not, and handles the received target information and location information as effective information when the two pieces of information are judged to be right.

23. The authentication system according to claim 22,
wherein the authentication server further includes:
a warning sending unit operable to send information showing a predetermined warning to the authentication terminal concerned when information that makes it possible to identify the received authentication terminal is judged to be wrong, and
the authentication terminal further includes:
a warning receiving unit that receives information showing the warning from the authentication server and represents the contents of the information concerned.

24. The authentication system according to claim 22,
wherein a sending unit of the authentication terminal further encrypts the target information and the location information, and sends the two pieces of information to the authentication server, and
the receiving unit of the authentication server further decrypts encrypted target information and location information that are received from the authentication terminal.

25. The authentication system according to claim 22,
wherein the authentication server further updates information that makes it possible to identify the authentication terminal and notifies the information to the authentication terminal based on the predetermined rule, and
the authentication terminal further updates information that makes it possible to identify the authentication terminal in response to a notification from the authentication server based on a predetermined rule.

26. A lock management system comprising:
a management server that controls a lock of a predetermined facility by grasping validity of a specific worker and a location where the worker exists; and
a worker terminal connected to the management server via a network; and
wherein the worker terminal includes:
a target information obtainment unit operable to obtain target information that characterizes the worker concerned from the worker,
a location information obtainment unit operable to obtain location information showing a location where the worker exists, and
a sending unit operable to send the obtained target information and the location information to the management server, and
the management server includes:
a receiving unit operable to receive the target information and the location information from the worker terminal,
a target information authentication unit operable to authenticate the worker based on the received target information, and
a location information judgment unit operable to judge whether a location where the worker exists is a safe location based on the received location information,
wherein the predetermined facility is locked when the worker is authenticated and it is judged that a location of the worker is a safe location.

27. A traveling management system comprising:
a management server that manages traveling to a predetermined visiting destination by grasping validity of a specific worker; and
a location and time where and when the worker concerned exists, and a worker terminal connected to the management server concerned via a network;
wherein the worker terminal includes:
a target information obtainment unit operable to obtain target information that characterizes the worker concerned from the worker,
a location information obtainment unit operable to obtain location information showing a location where the worker exists,
a time information obtainment unit operable to obtain time information showing time when the worker exists, and
a sending unit operable to send the obtained target information, the obtained location information and the obtained time information to the management server, and
the management server includes:
a receiving unit operable to receive the target information, the location information and the time information from a worker terminal,
a target information authentication unit operable to authenticate the worker based on the received target information,
a location information judgment unit operable to judge whether a location where the worker exists is right visiting destination or not based on the received location information,
a time information judgment unit operable to judge whether time when the worker exists is right based on the received time information, and
the traveling is judged to be right when the worker is authenticated and a location of the worker and time are judged to be a right location and time.

28. An authentication method for authenticating a specific object as a target, comprising:
a target information obtainment step of obtaining a first target information that characterizes the object concerned from the object;
a target information authentication step of authenticating the object based on the obtained target information; and
a location information addition step of associating the location information with the target information by obtaining location information showing a location where an object who is authenticated exists.

29. An authentication method for authenticating validity and existence of an object regarding a specific object as a target, comprising:
a target information obtainment step of obtaining target information that characterizes the object;
a location information obtainment step of obtaining location information showing a location where the object exists;
a target information authentication step of authenticating the object based on the obtained target information;
a location information authentication step of authenticating a location where an object exists based on the obtained location information; and
an existence authentication step of authenticating the object existing when the object and the location information are authenticated.

30. A program for an authentication apparatus for authenticating a specific object as a target, the program comprising:
a target information obtainment step of obtaining a first target information that characterizes the object concerned from the object;
a target information authentication step of authenticating the object based on the obtained target information; and
a location information addition step of associating the location information with the target information by obtaining location information showing a location where an object who is authenticated exists.

31. A program for an authentication apparatus for authenticating validity and existence of the object concerned regarding a specific object as a target, comprising:
a target information obtainment step of obtaining target information that characterizes the object;
a location information obtainment step of obtaining location information showing a location where the object exists;
a target information authentication step of authenticating the object based on the obtained target information;
a location information authentication step of authenticating a location where the object exists based on the obtained location information; and
an existence authentication step of authenticating the object existing when the object is authenticated and the location information is authenticated.
